(19) United States
(12) Patent Application Publication
(10) Pub. No.: US 2024/0100788 A1
(43) Pub. Date: Mar. 28, 2024

(54) LAY-UP METHOD OF COMPOSITE AIRCRAFT PARTS COMPRISING AN OPENING

(71) Applicant: Airbus Operations S.L.U., GETAFE (ES)

(72) Inventors: Yolanda MIGUEZ CHARINES, GETAFE (ES); Estelle BALIGAND, GETAFE (ES); Manuel RECIO MELERO, GETAFE (ES); Pedro CABRERA RODRIGUEZ, GETAFE (ES)

(21) Appl. No.: 18/474,585

(22) Filed: Sep. 26, 2023

(30) Foreign Application Priority Data
Sep. 27, 2022 (EP) 22382888.0

(51) Int. Cl. B29C 70/54; B29C 70/30

(52) U.S. Cl. CPC B29C 70/545; B29C 70/30; B29L 2031/3085

(57) ABSTRACT

A lay-up method of composite aircraft parts with an opening. Composite tows having an orientation of 0°, 90° or +/−45° are laid up forming plies which form a composite laminate. Each tow having an orientation of 0° and being within the perimeter of the opening comprises: a first gap located at approximately ⅗ of the length of the first semi-major axis from the center, the first gap being configured as a first elongated gap longitudinally perpendicular to the orientation of the tow, and a second gap located at approximately ⅗ of the length of the second semi-major axis from the center, the second gap being configured as a second elongated gap longitudinally perpendicular to the orientation of the tow.

### CROSS-REFERENCES TO RELATED APPLICATIONS

This application claims the benefit of European Patent Application Number 22382888.0 filed on Sep. 27, 2022, the entire disclosure of which is incorporated herein by way of reference.

### FIELD OF THE INVENTION

The invention relates to a lay-up method of composite aircraft parts, specifically carbon-fiber-reinforced polymers (CRFPs), comprising openings such as manholes or handholes.

### BACKGROUND OF THE INVENTION

A lay-up process is a molding process for composite materials, in which the final laminate is obtained by overlapping a specific number of different layers or plies.

Each layer or ply has an orientation of 0°, 90°, +/−45° and is made up of several tows laid up with an orientation of 0, 90°, +/−45°. 0°, zero-degree fiber angle are oriented in the direction of the load of the part.

Aircraft parts comprise several openings to carry out inspection tasks, assembly of systems, repairs, etc. An opening is a space or gap that allows passage or access. For instance, a manhole is an opening in an aircraft surface to allow the passage of a man or equipment to perform the above-mentioned tasks. A handhole is an opening in an aircraft surface to allow the passage of a hand. Therefore, a handhole is smaller than a manhole and allows only hand or small inspection equipment to pass through.

NACA inlets openings are also known that are surface openings in wings or horizontal tail planes (HTP) for the installation of NACA inlets.

Openings are mainly ovals, ellipses, or circumferences. Openings comprise a perimeter, a major axis, a minor axis, a center where both axes cross, a first and a second semi-major axis and a first and a second semi-minor axis departing from the center.

Layers and tows having an orientation of 0° are parallel to the major axis of the opening and layers and tows having an orientation of 90° are parallel to the minor axis of the opening.

Currently, most aircraft structures having openings, handholes or manholes, in their configuration are made of carbon-fiber-reinforced polymers (CFRP). The composite material may be laid-up automatically with automatic lay-up machines (ATL) or fiber lay-up machines (FLU).

Automatic lay-up machines (ATL) typically provide tows of 300 mm, 150 mm ó 75 mm width that are laid-up to manufacture the composite laminate. The width of the tow is the dimension of the tow in a direction perpendicular to its longitudinal direction or laying-up orientation.

Fiber lay-up machines (FLU) typically provide tows of 6.35 mm (¼″), 12.7 mm (½″) or 50.8 mm (2″). In the case of 2″ (50.8 mm) tows, it is sometimes referred to as HDPreg (High deposition preimpregnated).

Typically, ‘manholes’ or ‘handholes’ area is laid-up with extra material or scrap material. This extra material or scrap material is only needed for manufacturing purposes as it allows a vacuum bag to be adapted during curing. Therefore, the inner dimensions of the opening or perimeter, such as the diameter, is made intentionally undersize, and after the curing stage adjusted to its final dimension, usually by trimming methods. It is known that, to facilitate the fitting of the vacuum bag, the extra material or scrap material has a ramp geometry that smooths the contour of the manhole or handhole.

Therefore, during the lay-up of parts made of carbon-fiber-reinforced polymers (CFRP) that have ‘manholes’ and/or ‘handholes’, these areas are laid-up by covering an area that is an ‘offset’ or extra material from the final geometry and ramped to facilitate vacuum bag fitting. However, the material used in the ramp area is an additional cost of material and money.

Alternatively, the manholes or handholes are laid-up in their entirety and the opening is cut afterwards.

### SUMMARY OF THE INVENTION

In order to avoid the need for the above-mentioned ramp, the present invention provides methods which include the steps of laying-up composite tows forming plies that form a composite laminate.

In one or more embodiments, at least each tow having an orientation of 0° and being within the perimeter of the opening, i.e., having at least a part within the perimeter, comprises:
a first gap located at approximately ⅗ of the length of the first semi-major axis from the center, the first gap being configured as a first elongated gap longitudinally perpendicular to the orientation of the tow, and
a second gap located at approximately ⅗ of the length of the second semi-major axis from the center, the second gap being configured as a second elongated gap longitudinally perpendicular to the orientation of the tow.

Therefore, there is a first line and a second line approximately at ⅗ of the semi-major axis from the center of, for instance, the ellipse of the manhole or the radius of the circumference of the handhole. When each of the tows having an orientation of 0° crosses these lines, it comprises a gap.

In an embodiment, the automatic or manual laying-up of the tow shall be interrupted at the mentioned first and second lines and continued after the corresponding gap. The cutting and starting is performed leaving the mentioned gap. The tension of the tow is then released, facilitating the adaptation of the vacuum bag during curing.

Alternatively, if the laying up is made in a dedicated laying up tool, i.e., a tool without a curing purpose, the tows are laid-up to form the laminate and afterwards a cut of the thickness of the laid-up laminate is performed at the first line and at the second line of the opening to form the first and the second gap in each laid-up tow.

Thus, if the tool is only for laying up and not curing, it is possible to lay up the laminate to the full thickness and then make a cut in the two areas indicated to the full thickness of the laminate, without fear of damaging the tool, which could have some ridges in the area.

Without ramps, as disclosed in the state of the art, or without the mentioned gaps, as disclosed by the invention, the vacuum bag would not be able to fit the opening due to the tension of the tows. If the tows tension is high, the vacuum bag is not able to bend the tows with the vacuum pressure. As the contour of the tows is irregular, there could be a hole between tows. Although, the vacuum bag film has good elongation properties, it is not able to fit to these holes and it can be broken while curing.

The claimed invention has advantages over the previously mentioned state of the art. It allows the ramp area to be removed, as the adaptation of the vacuum bag is achieved thanks to the first and the second gaps. It reduces material waste and environmental impact by reducing the amount of material required for laying-up. It minimizes manufacturing scrap material needed, i.e., extra material required for proper manufacturing, and therefore it allows for material savings.

### BRIEF DESCRIPTION OF THE DRAWINGS

To complete the description and to provide for a better understanding of the invention, a set of drawings is provided. Said drawings form an integral part of the description and illustrate preferred embodiments of the invention. The drawings comprise the following figures.

FIG. 1 shows a schematic plan view and a cross-section of a manhole with scrap material or extra material and including a ramp area according to the state of the art.

FIG. 2 shows a schematic plan view of an embodiment of a manhole according to an embodiment of the invention.

### DETAILED DESCRIPTION OF THE PREFERRED EMBODIMENTS

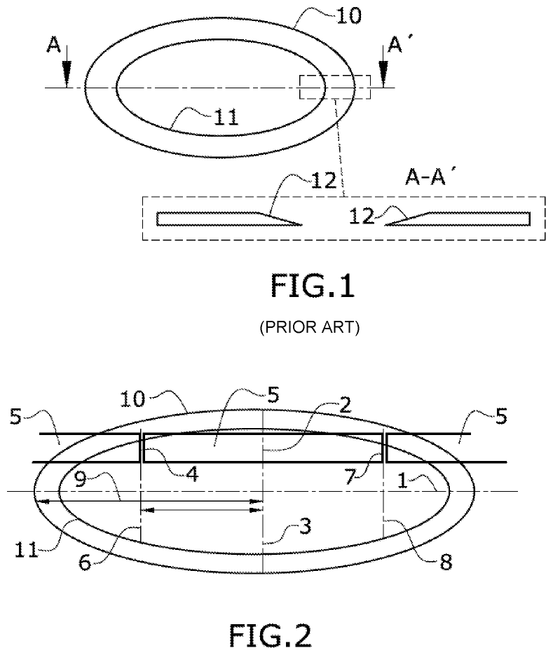

FIG. 1 discloses a schematic plan view and a cross-section of a manhole with manufacturing scrap material including a ramp area according to the state of the art. The schematic manhole comprises scrap material (11) disclosing the intermediate dimension of the manhole and the perimeter (10) of the final dimensions of the manhole. The manufacturing scrap material (11) comprises an area with a ramp (12) for allowing the positioning of the vacuum bag during the curing process of the composite laminate.

FIG. 2 discloses an opening comprising a perimeter (10), a major axis (1), a minor axis (2) and a center (3). One of the semi-major axis (9) is also depicted.

Although the shown embodiment discloses an opening being an ellipse, the major axis (1) and the minor axis (2) may have the same length so that the opening is a circumference.

FIG. 2 discloses a tow (5) having an orientation of 0°.

According to an embodiment of the invention, the tow (5) being laid-up comprises a first gap (4) and a second gap (7) between longitudinally consecutive laminated tow (5) portions. The first gap (4) is located at a first line (6) at ⅗ of the first semi-major axis (9) from the center (3) of the opening. The second gap (7) is located at a second line (8) at approximately ⅗ of the second semi-major axis (9) from the center (3) of the opening. By “approximately,” it is meant within 10%.

The first gaps (4) and the second gaps (7) of the tows (5) of the laminate are configured as a first and a second elongated gap located within the perimeter (10) of the opening and longitudinally perpendicular to the orientation of the tow (5), that are at least those tows (5) having an orientation of 0°. In the shown embodiment, the tows (5) having an orientation of 0° are parallel to the major axis (1). Preferably, the first and second gaps (4, 7) do not extend beyond the perimeter (10) of the opening.

In an embodiment, the method comprises the following steps:
laying-up a tow (5) having an orientation of 0° until approximately ⅗ of the first semi-major axis (9) of the opening from the center (3),
cutting the laid-up tow (5) at approximately ⅗ of the first semi-major axis (9) of the opening in a direction perpendicular to the orientation of the tow (5),
leaving the first gap (4) and continuing the lay-up of the tow (5) until approximately ⅗ of the second semi-major axis (9) of the opening from the center (3),
cutting the laid-up tow (5) at approximately ⅗ of the second semi-major axis (9) of the opening in a direction perpendicular to the orientation of the tow (5),
leaving the second gap (7) and continuing the lay-up of the tow (5),
repeating the above steps with at least the rest of the tows (5) having an orientation of 0° and located within the perimeter (10) of the opening.

According to the above, the tows (5) having an orientation of 0° should all be cut. In an embodiment, the tows (5) having an orientation of +/−45° are cut only if the laminate has many layers with this orientation. This is due because it is easier for the vacuum bag to adapt to the tows (5) having an orientation of +/−45°, even if they are not cut, due to their lower stiffness in the bending direction.

Therefore, in an embodiment the tows (5) having an orientation of +/−45° and being within the perimeter (10) of the opening may also comprise the first gap (4) and/or the second gap (7) or no gap depending on its position within the perimeter (10) and the needs.

Thus, the tows (5) having an orientation of +/−45° may comprise: the first gap (4) located at approximately ⅗ of the length of the first semi-major axis (9) from the center (3), the first gap (4) being configured as a first elongated gap longitudinally perpendicular to the orientation of the tow (5), and/or the second gap (7) located at approximately ⅗ of the length of the second semi-major axis (9) from the center (3), the second gap (7) being configured as a second elongated gap longitudinally perpendicular to the orientation of the tow (5).

The above embodiment may additionally comprise the following steps:
laying-up a tow (5) having an orientation of +/−45°,
if the tow (5) crosses the first line (6) located approximately at ⅗ of the first semi-major axis (9) of the opening from the center (3), cutting the laid-up tow (5) at approximately ⅗ of the first semi-major axis (9) of the opening perpendicular to the orientation of the tow (5),
leaving the first gap (4) and continuing the lay-up of the tow (5),
if the tow (5) crosses a second line (8) located approximately at ⅗ of the second semi-major axis (9) of the opening from the center (3) cutting the laid-up tow (5) at approximately ⅗ of the second semi-major axis (9) of the opening from the center (3) perpendicular to the orientation of the tow (5),
leaving the second gap (7) and continuing the lay-up of the tow (5).

As an alternative embodiment, in a first step, the tows (5), having an orientation of 0°, 90° or +/−45°, of the laminate are laid-up to form the laminate and, in a second step, a cut of the thickness of the laminate is performed at the first line (6), that is approximately ⅗ of the semi-major axis (9) of the opening, and at the second line (8), that is approximately ⅗ of the other semi-major axis (9) of the opening. The cut is configured as a first and a second elongated gap longitudinally perpendicular to the tows (5) having an orientation of 0°. It is understood as thickness of the composite laminate the smallest dimension of the laminate.

Therefore, the tows (5) are laminated without any cut or interruption at the first line (6), or the second line (8), and the gaps (4, 7) are formed afterwards by cutting the laminate.

This alternative embodiment is particularly useful if the lay-up tool is not the same as the curing tool. In that case, the cuts may be made without the risk of damaging the curing tool. The cuts can be made either with the blade of the laying head or manually. Full thickness cutting of the laminate should only be done if there is no risk of damaging the tool during curing.

In an embodiment, the first gap (4) and the second gap (7) are located in a range of ⅗ of the length of the first and the semi-major axis (9) from the center (3) +/−a width of the tow (5). Therefore, approximately means that the gap (4, 7) is located at ⅗ of the semi-major axis (9) plus the dimensions of the width of the tow (5) or minus the dimensions of the width of the tow (5).

In the shown embodiment, the gaps (4, 7) are perpendicular to a longitudinal axis of the laid-ups tows (5), i.e., are perpendicular to the direction of lay-up of the tows (5) with an orientation of 0°, which is parallel to the major axis (1). The tows (5) laid-up at a direction of 45° are cut perpendicularly to its laying-up direction.

Preferably, the width of the gaps (4, 7) is between 1.5 mm and 2 mm, i.e., the measurement of the gaps (4, 7) taken parallel to the major axis (1) of the opening (10).

The claimed invention is applicable to parts or laminates manufactured with CFRP tows (5) wider than 12.7 mm and having openings (10). The width of the tows (5) is taken perpendicularly to their laying-up direction. Examples of these aircraft parts are wings or horizontal tail planes (HTP).

It has to be considered that the geometry of the opening does not have dimensions that are a multiple of the tow (5) width, so the edges of the laid-up opening have an irregular geometry. The wider these tows (5) are, the more irregular the perimeter (10) is (the value of 12.7 mm marks the limit of irregularity) and the more difficult it is for the vacuum bag to fit.

In addition, for certain layers, ff the created gaps (4, 7) were inside the flying portion of the composite part, i.e., the gaps (4, 7) are located outside the opening, the position of the first (6) and second line (8) could be moved up to only one line coincident with the minor axis (2).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A lay-up method of composite aircraft parts comprising an opening, the opening comprising a perimeter, a major axis, a minor axis, a center, and a first semi-major axis and a second semi-major axis both departing from the center, the lay-up method comprising the steps of:
laying-up a plurality of composite tows having an orientation of 0°, 90° or +/−45° forming plies which in turn form a composite laminate,
wherein the composite tows having an orientation of 0° are parallel to the major axis of the opening,
wherein each composite tow having an orientation of 0° and being within the perimeter of the opening comprises:
a first gap located at approximately ⅗ of the length of the first semi-major axis from the center, the first gap being configured as a first elongated gap longitudinally perpendicular to the orientation of the composite tow, and
a second gap located at approximately ⅗ of a length of the second semi-major axis from the center, the second gap being configured as a second elongated gap longitudinally perpendicular to the orientation of the composite tow.

2. The lay-up method according to claim 1, further comprising the following steps:
laying-up a composite tow having an orientation of 0° until approximately ⅗ of the first semi-major axis of the opening from the center,
cutting the laid-up composite tow at approximately ⅗ of the first semi-major axis of the opening perpendicular to the orientation of the composite tow,
leaving the first gap and continuing the lay-up of the composite tow until approximately ⅗ of the second semi-major axis of the opening from the center,
cutting the laid-up composite tow at approximately ⅗ of the second semi-major axis of the opening perpendicular to the orientation of the composite tow,
leaving the second gap and continuing the lay-up of the composite tow,
repeating the above steps with at least one or more composite tows having an orientation of 0° and located within the perimeter of the opening.

3. The lay-up method according to claim 1, wherein tows having an orientation of +/−45° and being within the perimeter of the opening comprise:
the first gap located at approximately ⅗ of a length of the first semi-major axis from the center, the first gap being configured as a first elongated gap longitudinally perpendicular to the orientation of the composite tow; or
the second gap located at approximately ⅗ of a length of the second semi-major axis from the center, the second gap being configured as a second elongated gap longitudinally perpendicular to the orientation of the composite tow; or
both.

4. The lay-up method according to claim 3, wherein the method further comprises the following steps:
laying-up a composite tow having an orientation of +/−45°,
when the composite tow crosses a first line located approximately at ⅗ of the first semi-major axis of the opening from the center, cutting the laid-up composite tow at approximately ⅗ of the first semi-major axis of the opening perpendicular to the orientation of the tow,
leaving the first gap and continuing the lay-up of the composite tow,
when the composite tow crosses a second line located approximately at ⅗ of the second semi-major axis of the opening from the center cutting the laid-up composite tow at approximately ⅗ of the second semi-major axis of the opening from the center perpendicular to the orientation of the tow,
leaving the second gap and continuing the lay-up of the tow.

5. The lay-up method according to claim 1, wherein in a first step the composite tows are laid-up to form the laminate and in a second step a cut of a thickness of the laminate is performed at approximately ⅗ of the first and the second semi-major axis of the opening from the center to form the first and the second gaps as a first and a second elongated gap longitudinally perpendicular to the tows having an orientation of 0°.

6. The lay-up method according to claim 1, wherein the first gap and the second gap are located in a range of ⅗ of a length of the first and the semi-major axis from the center +/−a width of the composite tow.

7. The lay-up method according to claim 1, wherein a width in the direction parallel to the orientation of the composite tow of the first and the second gaps is between 1.5 mm and 2 mm.

8. The lay-up method according to claim 1, wherein the major axis and the minor axis of the opening have the same length.

9. The lay-up method according to claim 1, wherein a laminate tows width is greater than 12.7 mm.

10. The lay-up method according to claim 1, wherein the aircraft part is a wing or a horizontal tail plane (HTP).
